(19) United States
(12) Patent Application Publication
(10) Pub. No.: US 2014/0195240 A1
(43) Pub. Date: Jul. 10, 2014

(54) VISUAL CONTENT FEED PRESENTATION

(71) Applicant: CHAMELEON COLLECTIVE INC., Miami, FL (US)

(72) Inventors: Freddie Laker, Ft. Lauderdale, FL (US); Jody Brewster, Pembroke Pines, FL (US); Igor Guerrero, Miami, FL (US); Zachary Randall, Cooper City, FL (US); Reed Smith, Plantation, FL (US)

(73) Assignee: CHAMELEON COLLECTIVE INC., Miami, FL (US)

(21) Appl. No.: 13/737,456

(22) Filed: Jan. 9, 2013

(51) Int. Cl. G10L 13/08

(52) U.S. Cl. CPC G10L 13/08
USPC 704/260

(57) ABSTRACT

A method, system, and computer program product for a visual content feed presentation. The method includes receiving different streams of content from different sources of the streams, characterizing the content in each of the different streams, and determining based upon the characterization of the content of each of the streams, a visual arrangement of the content for presentation in a graphical user interface (GUI). The method further includes presenting the content in the determined visual arrangement in the GUI and text to speech (TTS) converting content in one of the streams and playing back the TTS converted content in synchronization with a display of an avatar in the GUI.

### BACKGROUND OF THE INVENTION

1. Field of the Invention

The present invention relates to web feeds and more particularly to displaying web feeds.

2. Description of the Related Art

Rich Site Summary (RSS) (originally RDF Site Summary), which is now referred to as Real Simple Syndication, is a family of web feed formats used to publish frequently updated works, such as blog entries, news headlines, audio, and video, in a standardized format. Atom Syndication Format (or just Atom) is also a format used for web feeds, which serves an alternative to RSS. An RSS or Atom document, which is called a feed, web feed, or channel, includes full or summarized text, headlines, links to content on a website, plus metadata such as publishing dates and authorship. RSS and Atom feeds can be read using software called a RSS or Atom reader, feed reader, or aggregator, which can be web-based, desktop-based or mobile-device-based. Both RSS and Atom files are usually Extensible Markup Language (XML) formatted plain text files.

Whether an Atom or RSS based file is used, a user subscribes to a feed by entering into the reader the URL of the feed or by clicking a feed icon in a web browser that initiates the subscription process. The feed reader checks the subscribed feeds of a user regularly for new work and downloads any updates that it finds. A feed reader allows a user to avoid manually inspecting all of the websites a user is interested in, and instead allows a user to subscribe to websites where all new content is pushed onto a browser of the user when it becomes available, but a user is limited to only reading the updates from the multiple sources.

Typically, if a user is interested in a particular blog, such as a blog covering a specific subject or a blog written by a specific author, the user from a content browser proceeds to the blog by entering a Uniform Resource Locator (URL) address for the blog in a web page. Once on the blog, the user can read what has been posted. As each post is only organized by chronological order with no categorization of posts by the user must read every post. Further, there is no optimized content targeted to a specific user. In addition, the content of a blog is formatted to be read from a computer; it is not formatted to be viewed from a “smart” TV.

### BRIEF SUMMARY OF THE INVENTION

Embodiments of the present invention address deficiencies of the art with respect to web feeds and provide a novel and non-obvious method, system, and computer program product for visual content feed presentation. In an embodiment of the invention, a visual content feed presentation method is provided and can include receiving different streams of content from different sources of the streams, characterizing the content in each of the different streams, and determining based upon the characterization of the content of each of the streams, a visual arrangement of the content for presentation in a graphical user interface (GUI). The method can further include presenting the content in the determined visual arrangement in the GUI and text to speech (TTS) conversion of content in one of the streams and playing back the TTS converted content in synchronization with a display of an avatar in the GUI.

Another embodiment of the invention provides for a visual content feed presentation data processing system. The system can include a server computing system including a server computer with memory, a processor, and a database. In addition, the system can include an operating system executing in the memory of the server as well as a visual content feed presentation server module hosted by the operating system. The visual content feed presentation server module can include program code for receiving different streams of content from different sources of streams from over a computer communications network, characterizing the content in each of the different streams, and determining based upon the characterization of the content of each of the streams a visual arrangement of the content for presentation in a graphical user interface (GUI). The module can further include program code for text to speech (TTS) conversion of content in one of the streams as well as delivery of the visual arrangements of the content, the TTS converted content, and a generated avatar to a client computer communicatively linked to the server computer over the computer communications network for display in a GUI of the client computer. The module can further include program code for configuring an avatar for display in the GUI of the client computer in synchronization with playing back in the GUI of the client computer of the TTS converted content.

Additional aspects of the invention will be set forth in part in the description that follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and, together with the description, serve to explain the principles of the invention. The embodiments illustrated herein are presently preferred; it being understood, however, that the invention is not limited to the precise arrangements and instrumentalities shown, wherein:

FIG. 1 is a pictorial illustration of a visual content feed presentation process;

FIG. 2 is a schematic illustration of a visual content feed presentation data processing system;

FIG. 3A is a flow chart illustrating a process on a server for displaying the content of a content feed and,

FIG. 3B is a flow chart illustrating a process designed for displaying the content of a content feed on a client.

### DETAILED DESCRIPTION OF THE INVENTION

Embodiments of the invention provide for a visual content feed presentation. In accordance with an embodiment of the invention, different content feeds from different blogs can be received. The content from the different feeds can be imported and stored. Thereafter, the stored content can be analyzed, so that a visual arrangement of the content can be determined. The content can be presented in a graphical user interface (GUI) according to the determined visual arrangement with text to speech (TTS) converted content played back in synchronization with an avatar in the GUI. In this way, a user can watch content from different blogs instead of having to read the content from separate blogs.

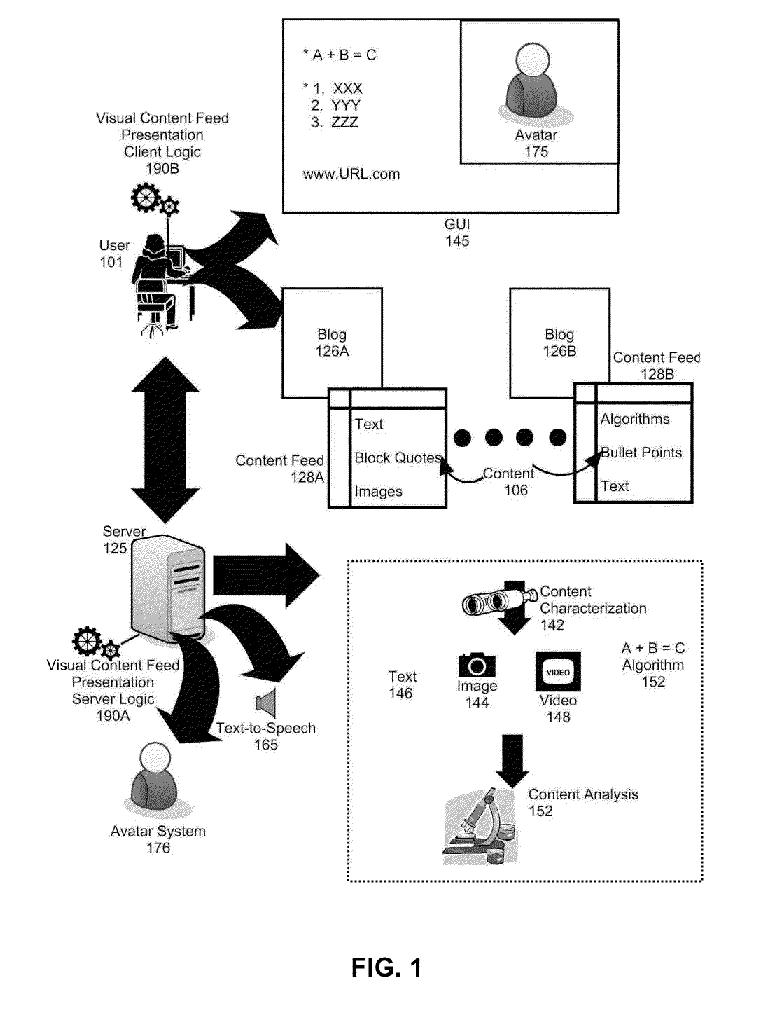

In further illustration, FIG. 1 depicts a visual content feed presentation process for displaying the content of a content feed 128A, 128B for a blog 126A, 126B. Visual content feed presentation server logic 190A on a server 125 can validate multiple, different content feeds 128A, 128B that a user 101 on a computing device has subscribed to in response to the user 101 requesting that his or her blogs 126A, 126B be visually displayed in a graphical user interface (GUI) 145. Each content feed 128A, 128B can be validated to ensure that any subscribed content feed corresponds to a blog. The content feeds 128A, 128B can include both RSS formatted feeds and Atom formatted feeds.

Optionally, the logic 190A can discover blogs 126A, 126B that may be of interest to a user 101 but to which a user 101 has not yet subscribed. For instance, a user 101 who has subscribed to a variety of blogs discussing Miami-based sports teams may be interested in a blog by a coach of a Miami-based sports team. The visual content feed presentation server logic 190A may present the discovered blog(s) 126A, 126B to the user 101 for approval before processing the content 106 or may import the content 106 from the content feed 128A, 128B for the discovered blog without getting the approval of the user 101.

Upon the validation of the content feed 128A, 128B, the visual content feed presentation server logic 190A can import and store the content 106 from the different content feeds 128A, 128B. Of note, the visual content feed presentation server logic 190A can also import content via a web service or multiple, different web services, which can each also be validated. In other words, logic 190A can receive different streams of content from different sources of the stream. In one embodiment, the content can be stored in a database (not shown). Of note, the content 106 can be separated as individual assets during the importation of the content 106 from the content feeds 128A, 128B. Content 106 obtained from the content feed 128A, 128B can include, but is not limited to, text 146, images 144, audio (files), video (files) 148, and metadata. Of note, the content 106 can also be in the form of block quotes, algorithms 152, bullet points, numbered lists, and math and science equations. The metadata can include, but is not limited to, information pertaining to the blog 126A, 126B, such as the originating uniform resource locator (URL), the author(s), the date, and any tags. Of note, additional content 106 located on a web page upon which a blog appears may also be imported. Of further note, not all content 106 may be imported. For example, an image 144 must fall within a threshold range in order to be imported. In an embodiment, images larger than five megabytes and smaller than two hundred fifty bytes may not be imported. Of note, the content 106 can also be stored in a cache. Of further note, the data in a cache can be use as part of an optionally feed navigation system. In an embodiment, the feed navigation system can include a feed navigation module enabled to display previews of the content feed posts in a text format before launching the posts based on the original content feeds 128A, 128B.

Upon the importation of the content 106, the content 106 can be processed. More specifically, in an embodiment, the content 106 can be characterized 142 to determine whether it is standard content or non-standard content. In an embodiment, non-standard content can include, but is not limited to, text 146 in the form of block quotes, bullet points, algorithms 152, numbered lists, URLs, and math and science equations. Standard content, can include, but is not limited to, text 146, images 144, video 148, and audio (files). Of note, standard text content can include, but is not limited to, isolated text 146 in the form of articles, headlines, abstracts, and synopses. It is noted that an algorithm 152 as well as a science or math equation may be a text string or an image 144, saved as a jpeg file, a tiff file, or some other format. Typically, an algorithm or equation presented as a text string will be identified as non-standard content, but when presented as an image 144, the algorithm or equation will be treated as standard content. Standard text content (text 146, not including abnormalities like bullet points, block quotes, algorithms, etc.) can be text to speech (TTS) 165 converted. Of note, TTS 165 can be accomplished with a third party application executing in memory of the server 125, integrated with the visual content feed presentation server logic 190A, a third party application on a third party device, or a third party application on a computing device of a user 101.

After content characterization 142, the content 106 that has been identified and separated as individual assets can be further analyzed 152 to determine based upon the characterization of the content 106, a visual arrangement of the content 106 for presentation in a GUI 145. For instance, the visual content feed presentation server logic 190A, during its analysis, may elect to display bullet points directly to a user 101 instead of having an avatar 175 generated by the avatar system 176 vocalize the bullet points. In one embodiment, an algorithm can be applied to the content 106 so that different parameters of each piece of content can be determined. For instance, the algorithm can determine, among other parameters, length, dimension, quantity, and quality for each piece of content 106. Based upon the determined parameters for a piece of characterized content, a visual arrangement of the content can be determined. In one embodiment, the visual arrangement is determined via a lookup table that maps content properties to meta-data describing a visual arrangement. In a different embodiment, the visual arrangement is hard-coded based on determined parameters. Further, the algorithm can determine the appropriate timing of the playback of multiple, different pieces of content 106 based, in part, on the parameters. For example, the algorithm can determine when one piece of content 106 should be presented with a different piece of content 106 (the visual arrangement), such as playing a video clip of a movie trailer and displaying locations of local showings of the movie at the same time.

In addition, the visual content feed presentation server logic 190A can send a request to an avatar system 176 to generate an avatar 175. Of note, the avatar system 176 is not specifically defined, but can be any system by which an avatar can be generated. The avatar 175 can be utilized in order to “speak” the TTS 165 converted content to a user 101 during playback.

Upon the determination of the logic for how content 106 will be visually arranged for presentation to a user 101, the visual arrangement of the content 106, the TTS converted content, and the generated avatar 175 can be delivered to a computing device of a user 101 for reassembly 102 and display according to the logic developed by the visual content feed presentation server logic 190A. In an embodiment, visual content feed presentation client logic 190B can reassemble and present the determined visual arrangement of the content 106 as well as playback TTS converted content in synchronization with the generated avatar 175. In a different embodiment, server logic 190A delivers the visual arrangement of the content 106 (or the logic for the visual arrangement of the content 106), the TTS converted content, and the generated avatar 175 to a client computer for display in a GUI 145 on the client computer, so that the TTS converted content can be played back in synchronization in the GUI on the client computer. The GUI 145 in FIG. 1 illustrates an embodiment of how the content 106 can be reassembled and presented to a user 101. The content 162 can be presented in the GUI 145 in the determined visual arrangement while TTS converted content is played back in synchronization with the display of an avatar 175. In other words, an avatar 175 can “read” standard text-based content while other content, such as additional text 146, URLs, numbered lists, algorithms 152, is displayed at a time determined by visual content feed presentation server logic 190A. In this way, a user 101 can watch his or her favorite blog(s) 126A, 126B. Of note, a user 101 can also skip posts that he or she is not interested in.

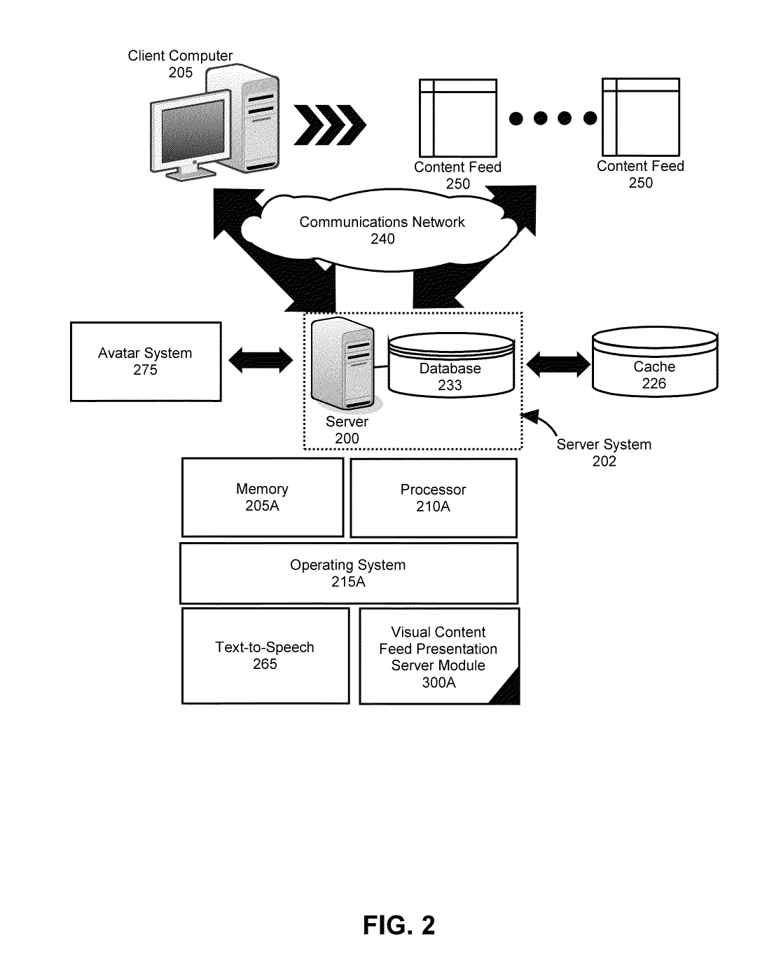

The process described in connection with FIG. 1 can be implemented in a visual content feed presentation data processing system of FIG. 2. The system can include a client computer 205 communicating via a communications network 240 with a server 200 in a server system 202. Of note, though only one client computer 205 is shown, there can be multiple, different client computers 205. In addition, the client computer 205 with memory, an operating system, and at least one processor can host a visual web client module (not shown). The server system 202 can include a server 200 that is coupled to a database 233. The server 200 can further include at least one processor 210A and memory 205A supporting the execution of an operating system 215A. The operating system 215A in turn can support text-to-speech (TTS) 265 and a visual content feed presentation server module 300A. In addition, the server system 202 can be coupled to an avatar system 275 and a cache 226. Optionally, the server 200 can be coupled to a feed navigation module (not shown). Of further note, the feed navigation module can include program code, which when executed by at least one processor on the server 200 can display previews of the content feed posts in a text format before launching them based on the original content feeds.

The visual web server module 300A hosted by the operating system 215A can include program code, which when executed by at least one processer 210A of the server 200 receives different streams of content from different sources of the streams from over the computer communications network 240. In other words, the module 300A can receive different content feeds 250, each content feed 250 from a different blog. In one embodiment, a stream of content can be a Really Simple Syndication (RSS) feed, and in a different embodiment, a stream of content can be an Atom-based feed. In a different embodiment, a stream of content can be received from a web service or multiple, different web services. Upon receiving different streams of content, the content from each of the different streams can be imported and stored. Each piece of content can be stored in the database 233. In other words, text can be imported and stored separately from images, which can be imported and stored separately from audio-based content, which can be imported and stored separately from metadata. In this way, the separated content can be analyzed individually and processed as such. Of note, in an embodiment, only portions of a content feed 250 or a web site associated with a content feed 250 may be imported.

Of further note, the content imported from any identified content feeds 250 can further be stored in a cache 226. The content stored in the cache 226 can be used to populate a feed navigation module (not shown).

Upon the storage of the content, the visual content feed presentation server module 300A can include program code to characterize the content in each of the different streams to identify the type of content from different types of content. Of note, each separately stored item can be characterized. The program code of the visual content feed presentation server module 300A can further be enabled to determine based upon the characterization of the content of each of the streams, a visual arrangement of the content for presentation in a graphical user interface (GUI). In this way, the module 300A can determine how the characterized content should be displayed in relation to other different characterized types of content as well as when the identified type of content should be displayed. For example, the visual presentation of when one piece of content should be presented with a different piece of content, such as playing a video clip of a movie trailer and displaying local showings of the movie at the same time.

Further, the module 300A can be enabled to text to speech (TTS) 265 convert content in one of the streams. In other words, content characterized as isolated text can be converted from text to speech. In addition, the visual content feed presentation server module 300A can include program code enabled to deliver the visual arrangement of the content as well as the TTS converted content and a generated avatar to the client computer 205 over the computer communications network 240 for display in a GUI. More specifically, upon a determination by the visual content feed presentation server module 300A of the logic defining the visual arrangement of the content for presentation in a GUI, the content can be reassembled and displayed at the client computer 205.

The visual content feed presentation server module 300A can further include program code enabled to configure an avatar for display in the GUI of the client computer 205 in synchronization with a playing back in the GUI of the client computer 205 of the TTS converted content. Of further note, the server module 300A can forward a request to an avatar system 275, so that an avatar can be created.

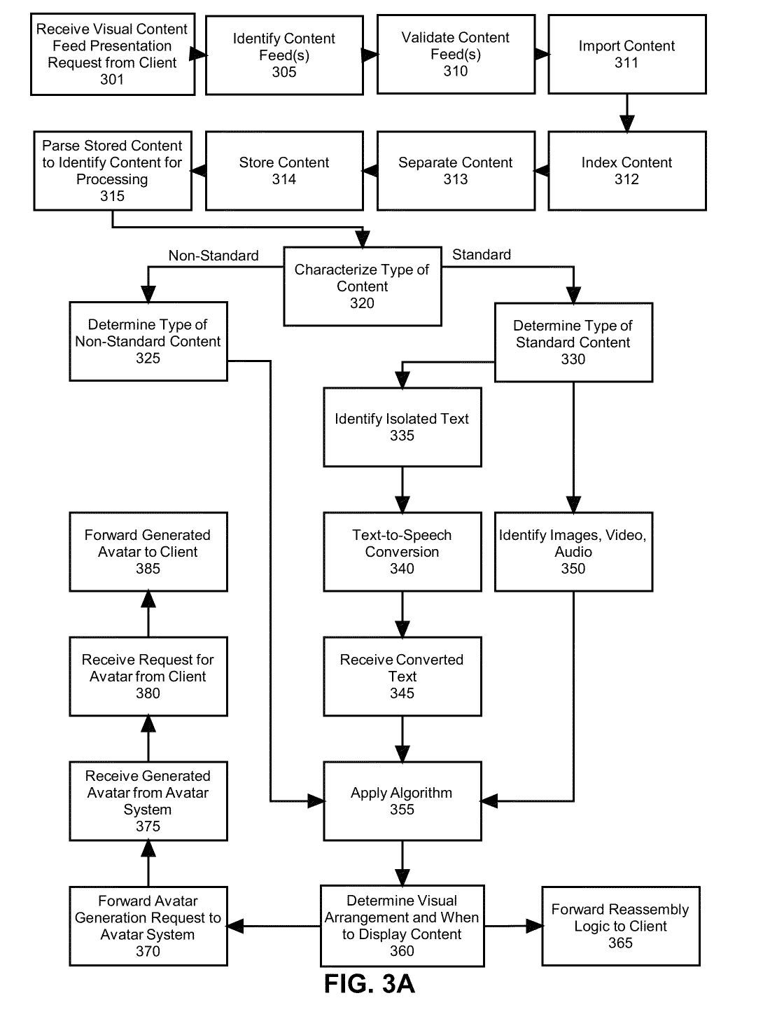

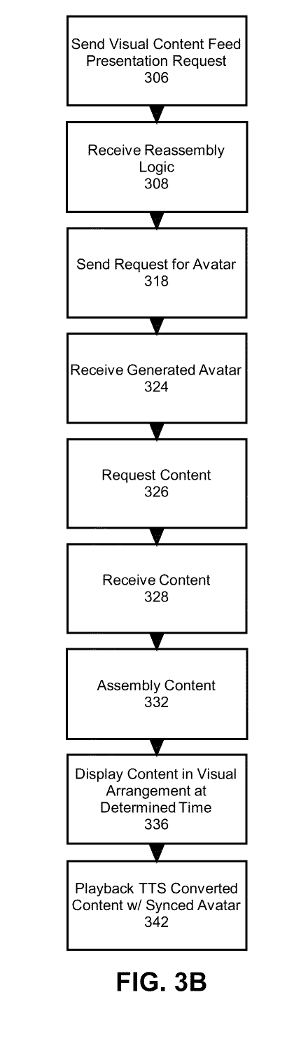

In yet even further illustration of the operation of the program code of the visual content feed presentation server module, FIG. 3A is a flow chart illustrating a process employed by a server for displaying the content of a content feed. Beginning in block 301, a request from a client computer for a content feed to be displayed can be received. In block 305, at least one content feed can be identified and validated, as shown in block 310. Of note, the visual content feed presentation server module can optionally discover content feeds to which a user may not be subscribed. Optionally, the visual content feed presentation server module can also import content via a web service or multiple, different web services. Further, the visual content feed server presentation module can also validate the web service or services.

Upon the validation of each content feed, the content from the feed can be imported, as shown in block 311. In one instance, the content can be scraped from each content feed. Of note, additional content located on a web page upon which a blog appears may also be imported. Of further note, in an embodiment, not all content that is part of a content feed or a website may be imported and stored. In another embodiment, all content that is scraped is stored. Further, as shown in block 312, the content can be indexed as well as separated, as illustrated in block 313, and stored, as in block 314. In this way, each piece of content is stored separately and can be analyzed separately. Of note, the content can be stored in a database.

The stored content can then be parsed to identify content for additional processing, as indicated in block 315. In this way, appropriate content can be identified, as not all content imported from a content feed or a website may be appropriate for further processing. Optionally, the content identified as appropriate for further processing can be imported from the database. Once content is identified as appropriate for further processing, each piece of content can be separately analyzed to characterize what type of content the piece is, as shown in block 320. In an embodiment, the content can be identified as standard content or non-standard content.

If in block 320, the content is identified as standard content, then the type of standard content can be determined, as shown in block 330. Content identified as isolated text (text not including abnormalities like bullet points, block quotes, algorithms, etc.), as in block 335, can be forwarded for text-to-speech conversation, as illustrated in block 340. Upon the conversion of the isolated text to speech, the audio file containing the converted text can be received, as in block 345. If in block 320, the content is identified as non-standard, then the type of non-standard content can be determined, as shown in block 325.

As shown in block 355, an algorithm can be applied to the identified standard content (the images, videos, and/or audio shown in block 350 and the received audio file in block 345) as well as the identified non-standard content, in block 325. In an embodiment, the algorithm is used to determine different parameters for each piece of content. The parameters can then be used to determine the logic for the visual arrangement of the content and when the content should be displayed, as indicated in block 360. More specifically in one embodiment, the visual arrangement can be determined via a lookup table that maps content properties to metadata describing a visual arrangement. In a different embodiment, the visual arrangement is hard-coded based on determined parameters for each piece of content. In addition, the algorithm can analyze the multiple, different parameters in order to determine the appropriate timing of the playback of multiple, different pieces of content based, in part, on the parameters. For example, the algorithm can determine when one piece of content should be presented with a different piece of content, such as playing a video clip of a movie trailer and displaying local show times of the movie simultaneously. In other words, the algorithm assists in determining the logic, which a client computer will use to reassemble the content for a user. As shown in block 365, the reassembly logic related to the visual arrangement of the content and when to display content can be forwarded to a client computer (to a visual content feed client presentation module, for instance).

Further, the program code of the visual content feed presentation server module can forward a request to an avatar system to generate an avatar, as shown in block 370. Then the generated avatar can be received from the avatar system, as illustrated in block 375. In addition, the visual content feed presentation server module can receive a request from the client computer for an avatar, as in block 380. A generated avatar can be forwarded to the client computer, as shown in block 385. In this way, it is the visual content feed presentation server module that interacts with the avatar system directly. It is noted that in another embodiment, the client computer can interact directly with the avatar system.

Of note, in an embodiment of the invention, a visual content feed presentation client module can be hosted by an operating system of a client computer that can include program code, which when executed by at least one processer of the client computer can display a GUI in which TTS converted content is played back in synchronization with an avatar. FIG. 3B is a flow chart illustrating an embodiment of such a process on a client computer. Beginning in block 306, a visual content feed presentation request can be sent to a server executing the visual content feed presentation server module. Upon the processing of the content of different streams of content from different sources of the streams by the visual content feed presentation server module, the reassembly logic developed by the server module can be received, as shown in block 308. The reassembly logic includes information detailing the determined visual arrangement of the content for presentation in a GUI on the client computer as well as the timing related to when content is displayed. The client module can further send a request for an avatar, as in block 318. In an embodiment, the request for the avatar can be sent to the visual content feed presentation server module, which interacts with an avatar system. In a different embodiment, the request for an avatar can be sent directly to an avatar system. An avatar can be received after its creation, as shown in block 324. As illustrated in block 326, the previously stored content, which is to be displayed according to the determine visual arrangement, as well as the audio file created by the text-to-speech conversion can be requested and then received, as shown in block 328. As shown in block 332, the received content (each content element) can be assembled for display, and then each content element can be displayed at a time determined by the program code of the visual content feed presentation server module, as is indicated in block 336. In this way, the content can be presented according to the determined visual arrangement (as determined by the visual content feed presentation server module) in a GUI at the client computer. In addition, during playback, TTS converted content can be synchronized with an avatar for display in the GUI, as shown in block 342.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied therein.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by, or in connection with, an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by, or in connection with, an instruction execution system, apparatus, or device.

Program code embodied in a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object-oriented programming language and conventional procedural programming languages. The program code may execute entirely on the computer of the user, partly on the computer of the user, as a stand-alone software package, partly on the computer of the user and partly on a remote computer, or entirely on a remote computer or server. In the latter scenario, the remote computer may be connected to the computer of the user through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks sometimes may be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, a special purpose computer, or another programmable data processing apparatus to produce a machine, such that the instructions, which execute via the processor of the computer or other programmable data processing apparatus, create means for implementing the functions/acts specified in the flowchart(s) and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart(s) and/or block diagram block or blocks. The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart(s) and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention in various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A visual content feed presentation method comprising:
receiving different streams of content from different sources of the streams;
characterizing the content in each of the different streams;
determining based upon the characterization of the content of each of the streams, a visual arrangement of the content for presentation in a graphical user interface (GUI);
presenting the content in the determined visual arrangement in the GUI; and,
text to speech (TTS) converting content in one of the streams and playing back the TTS converted content in synchronization with a display of an avatar in the GUI.

2. The method of claim 1, wherein one of the different streams of content is a Really Simple Syndication (RSS) feed.

3. The method of claim 1, wherein one of the different streams of content is an Atom-based feed.

4. The method of claim 1, wherein one different source of the streams is a blog.

5. A visual content feed presentation data processing system, comprising:
a server computing system comprising a server computer with memory, a processor, and a database;
an operating system executing in the memory of the server;
a visual content feed presentation server module hosted by the operating system, the module comprising program code enabled to receive different streams of content from different sources of the streams from over a computer communications network, to characterize the content in each of the different streams, to determine based upon the characterization of the content of each of the streams a visual arrangement of the content for presentation in a graphical user interface (GUI), to text to speech (TTS) convert content in one of the streams and to deliver each of the visual arrangement of the content, the TTS converted content, and a generated avatar to a client computer communicatively linked to the server over the computer communications network for display in a GUI of the client computer, the module configuring an avatar for display in the GUI of the client computer in synchronization with a playing back in the GUI of the client computer of the TTS converted content.

6. The system of claim 5, wherein one of the different streams of content is a Really Simple Syndication (RSS) feed.

7. The system of claim 5, wherein one of the different streams of content is an Atom-based feed.

8. The system of claim 5, wherein one different source of the streams is a blog.

9. A computer program product for visual content feed presentation, the computer program product comprising:
a computer readable storage medium having computer readable program code embodied therewith, the computer readable program code comprising:
computer readable program code for receiving different streams of content from different sources of the streams;
computer readable program code for characterizing the content in each of the different streams
computer readable program code for determining based upon the characterization of the content of each of the streams, a visual arrangement of the content for presentation in a graphical user interface (GUI);
computer readable program code for presenting the content in the determined visual arrangement in the GUI; and,
computer readable program code for text to speech (TTS) converting content in one of the streams and playing back the TTS converted content in synchronization with a display of an avatar in the GUI.

10. The computer program product of claim 9, wherein one of the different streams of content is a Really Simple Syndication (RSS) feed.

11. The computer program product of claim 9, wherein one of the different streams of content is an Atom-based feed.

12. The computer program product of claim 9, wherein one different source of the streams is a blog.
